(19) United States
(12) Patent Application Publication
(10) Pub. No.: US 2024/0308898 A1
(43) Pub. Date: Sep. 19, 2024

(54) GLASS WINDING SYSTEM AND SYSTEM AND METHOD FOR FORMING GLASS ROLLS

(71) Applicant: CORNING INCORPORATED, CORNING, NY (US)

(72) Inventors: EuiHo Kim, Asan-si (KR); Ga-Hyun Kim, Asan-si (KR); Junwoo Kim, Asan-si (KR)

(21) Appl. No.: 18/577,887

(22) PCT Filed: Jul. 7, 2022
(86) PCT No.: PCT/US2022/036303

§ 371 Date: Jan. 9, 2024

(30) Foreign Application Priority Data
Jul. 9, 2021 (KR) 10-2021-0090215

(51) Int. Cl. C03B 23/03; C03B 33/023; C03B 33/037; C03B 33/10

(52) U.S. Cl. CPC C03B 23/0305; C03B 33/0235; C03B 33/037; C03B 33/107

(57) ABSTRACT

Provided is a glass winding system configured to switch between a breaking mode and a winding mode in which glass is wound with an interleaf to form the glass roll. Furthermore, a system for forming glass rolls includes a glass ribbon supply system (100), a cutting system (200) configured to cut the initial glass ribbon into a first glass ribbon and a second glass ribbon, a first glass winding system (400) configured to wind the first glass ribbon to form a first glass roll, and a second glass winding system (300) configured to switch between a breaking mode and a winding mode.

### BACKGROUND

### 1. Cross-Reference to Related Application

This application claims the benefit of priority under 35 U.S.C. § 119 of Korean Patent Application No. 10-2021-0090215 filed Jul. 9, 2021, the content of which is incorporated herein by reference in its entirety.

### 2. FIELD

The disclosure relates to a glass winding system, a system for forming glass rolls including the glass winding system, and a method for forming glass rolls using the glass winding system.

### 3. DESCRIPTION OF THE RELATED ART

Glass having a thin thickness may be bendable and flexible. The bendable and flexible glass may be used as a material for flexible displays, wearable electronic devices, and building interior and exterior decorations. The flexible glass may be stored and transported in the form of a glass roll in which glass is wound in a roll shape. A necessary width of glass may vary according to the use of an end customer. A glass roll having a portion of a necessary width may be obtained from an initial glass roll and then the other portion with remaining widths may be disposed of. In this case, a considerable amount of a portion of a glass roll may be wasted. This may cause an increase in the unit price of a glass roll.

### SUMMARY

Provided are a system and method for forming glass rolls having a desired width at a low unit price, and a glass winding system used for the system and method.

Additional aspects will be set forth in part in the description which follows and, in part, will be apparent from the description, or may be learned by practice of the presented embodiments of the disclosure.

A glass winding system according to embodiments of present disclosure may comprise a glass winder configured to wind glass with an interleaf to form a glass roll, an interleaf unwinder configured to unwind the interleaf from an interleaf roll, and a breaking unit configured to break the glass, The glass winding system may be configured to switch between a breaking mode in which the glass is broken and a winding mode in which the glass is wound with the interleaf to form the glass roll.

In some embodiments, the breaking unit may be configured to rotate with respect to a rotation axis to allow the glass winding system to switch between the breaking mode and the winding mode.

In some embodiments, the glass winding system may further comprise a first roller used at a first position in the winding mode. The first roller may be removed from the first position in the breaking mode.

In some embodiments, the glass winding system may further comprise a second roller used at a second position in the winding mode. The second roller may be removed from the second position in the breaking mode. The glass winding system may further comprise a roller holder configured to hold the second roller in the breaking mode.

In some embodiments, the glass winding system may be arranged on a floor. The glass winder may be arranged between the floor and the interleaf unwinder.

In some embodiments, the glass winder may be configured to switch between a clockwise mode in which the glass is wound clockwise with the interleaf and a counterclockwise mode in which the glass is wound counterclockwise with the interleaf.

In some embodiments, the glass winding system may further comprise a third roller used in the clockwise mode and not used in the counterclockwise mode, and a fourth roller used in the counterclockwise mode and not used in the clockwise mode.

In some embodiments, the glass winding system may further comprise a first diameter sensor configured to measure a diameter of the glass roll, and a first sensor moving unit configured to move the first diameter sensor in a direction parallel to a rotation axis of the glass roll.

In some embodiments, the glass winding system may be configured to control a tension of the glass according to the diameter of the glass roll.

In some embodiments, the glass winding system may further comprise a load cell roller configured to sense a tension of the glass.

In some embodiments, the glass winding system may further comprise a dancer roller configured to control a tension of the glass.

In some embodiments, the glass winding system may further comprise a second diameter sensor configured to measure a diameter of the interleaf roll, and a second sensor moving unit configured to move the second diameter sensor in a direction parallel to a rotation axis of the interleaf roll.

In some embodiments, the glass winding system may further comprise a position sensor configured to sense a position of the glass in a direction parallel to a rotation axis of the glass roll, and a moving device configured to move the glass winder according to a position of the glass.

A system for forming glass rolls according to embodiments of present disclosure may comprise a glass ribbon supply system configured to supply an initial glass ribbon, a cutting system configured to cut the initial glass ribbon into a first glass ribbon and a second glass ribbon, a first glass winding system configured to wind the first glass ribbon to form a first glass roll, and a second glass winding system configured to switch between a breaking mode in which the second glass ribbon is broken and a winding mode in which the second glass ribbon is wound to form a second glass roll.

In some embodiments, the glass ribbon supply system may comprise a glass unwinder configured to unwind the initial glass ribbon from an initial glass roll.

In some embodiments, the second glass winding system may comprise

In some embodiments, the second glass winding system may further comprise a first roller used at a first positon in the winding mode. The first roller is removed from the first position in the breaking mode.

In some embodiments, the second glass winding system may further comprise a second roller used at a second position in the winding mode, The second roller may be removed from the second position in the breaking mode. The second glass winding system may further comprise a roller holder configured to hold the second roller in the breaking mode.

In some embodiments, the second glass winding system may further comprise an interleaf unwinder configured to unwind an interleaf from an interleaf roll, The second glass winding system may be arranged on a floor, and the glass winder may be arranged between the floor and the interleaf unwinder.

In some embodiments, the glass winder may be configured to switch between a clockwise mode in which the second glass ribbon is wound clockwise and a counterclockwise mode in which the second glass ribbon is wound counterclockwise.

In some embodiments, the second glass winding system may further comprise a third roller used in the clockwise mode and not used in the counterclockwise mode, and a fourth roller used in the counterclockwise mode and not used in the clockwise mode.

In some embodiments, the second glass winding system may further comprise a first diameter sensor configured to measure a diameter of the second glass roll, and a first sensor moving unit configured to move the first diameter sensor in a direction parallel to a rotation axis of the second glass roll.

In some embodiments, the second glass winding system may be configured to control a tension of the second glass ribbon according to the diameter of the second glass roll.

In some embodiments, the second glass winding system may further comprise a load cell roller configured to sense a tension of the second glass ribbon.

In some embodiments, the second glass winding system may further comprise a dancer roller configured to control a tension of the second glass ribbon.

In some embodiments, the second glass winding system may further comprise an interleaf unwinder configured to unwind an interleaf from an interleaf roll, a second diameter sensor configured to measure a diameter of the interleaf roll, and a second sensor moving unit configured to move the second diameter sensor in a direction parallel to a rotation axis of the interleaf roll.

In some embodiments, the second glass winding system may further comprise a position sensor configured to sense a position of the second glass ribbon in a direction parallel to a rotation axis of the second glass roll, and a moving device configured to move the glass winder according to a position of the second glass ribbon.

In some embodiments, the second glass winding system may be arranged between the cutting system and the first glass winding system.

A method of forming glass rolls according to embodiments of present disclosure may comprise supplying an initial glass ribbon from a supply region to a cutting region, cutting the initial glass ribbon into a first glass ribbon and a second glass ribbon in the cutting region, winding the first glass ribbon to form first glass roll in first winding region, breaking the second glass ribbon in a second winding region, moving the first glass roll from the first winding region to the supply region, supplying the first glass ribbon from the supply region to the cutting region by unwinding the first glass ribbon from the first glass roll, cutting the first glass ribbon into a third glass ribbon and a fourth glass ribbon in the cutting region, winding the third glass ribbon to form a second glass roll in the first winding region, and winding the fourth glass ribbon to form a third glass roll in the second winding region.

In some embodiments, the supplying the initial glass ribbon may comprise unwinding the initial glass ribbon from an initial glass roll.

In some embodiments, the breaking of the second glass ribbon and the winding the fourth glass ribbon are performed by a glass winding system located in the second winding region.

In some embodiments, the switching the glass winding system may comprise rotating a breaking unit included in the glass winding system.

In some embodiments, the switching the glass winding system may comprise inserting at least one roller into the glass winding system.

In some embodiments, the method may further comprise sensing a position of the fourth glass ribbon in a direction parallel to a rotation axis of the third glass roll during the winding of the fourth glass ribbon, and moving the third glass roll in the direction according the position of the fourth glass ribbon during the winding of the fourth glass ribbon.

In some embodiments, the method may further comprise sensing a diameter of the third glass roll during the winding of the fourth glass ribbon, and controlling a tension of the fourth glass ribbon according to the sensed diameter of the third glass roll.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a glass winding system according to an embodiment of the disclosure;

FIG. 2 is a schematic side view of the glass winding system of FIG. 1;

FIG. 3 is a schematic view of a system for forming glass rolls according to an embodiment of the disclosure;

FIGS. 4 and 5 are plan views of a method of forming glass rolls according to an embodiment of the disclosure; and

FIG. 6 is a schematic view of a glass ribbon supply system included in a system for forming glass rolls according to an embodiment of the disclosure and used for a method of forming glass rolls according to an embodiment of the disclosure.

### DETAILED DESCRIPTION

The disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Like reference numerals in the drawings denote like elements. Furthermore, various elements and areas are schematically illustrated in the drawings. Accordingly, the concept of the disclosure is not limited by relatively sizes or intervals illustrated in the accompanying drawings.

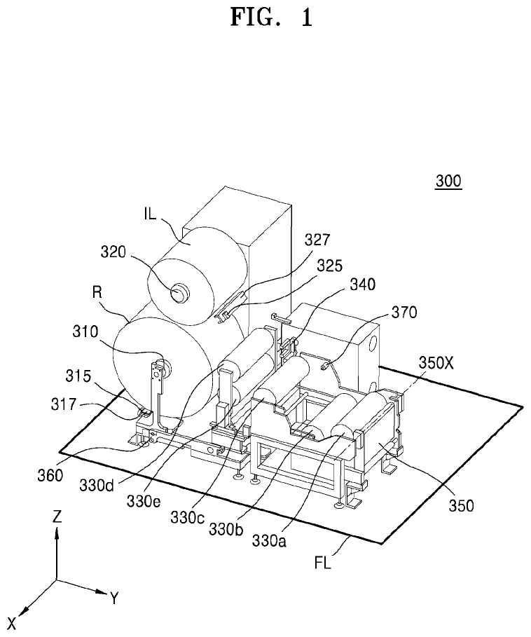

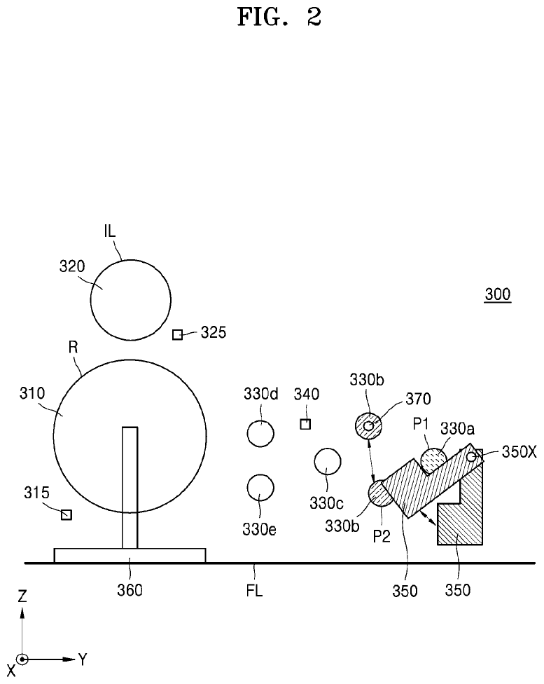

FIG. 1 is a perspective view of a glass winding system 300 according to an embodiment of the disclosure. FIG. 2 is a schematic side view of the glass winding system 300 of FIG. 1.

Referring to FIGS. 1 and 2, the glass winding system 300 may include a glass winder 310, an interleaf unwinder 320, and a breaking unit 350. The glass winder 310 may be configured to wind glass with an interleaf to form a glass roll R. The interleaf unwinder 320 may provide the interleaf to the glass winder 310 by unwinding the interleaf from an interleaf roll IL. The breaking unit 350 may be configured to break the glass. The breaking unit 350 may be arranged adjacent to an entrance through which the glass comes into the glass winding system 300, and the interleaf unwinder 320 and the glass winder 310 may be arranged away from the entrance.

The glass winding system 300 may be arranged on a floor FL. In some embodiments, the glass winder 310 may be arranged between the floor FL and the interleaf unwinder 320. In other words, the glass winder 310 may be arranged under the interleaf unwinder 320. As the glass winder 310 is generally heavier than the interleaf unwinder 320, and the glass winder 310 that is relatively heavy is arranged under the interleaf unwinder 320 that is relatively light, structural stability may be secured.

In some embodiments, the glass winding system 300 may include at least one roller, for example, first to fifth rollers 330a to 330e, to move the glass within the glass winding system 300. In other words, the first to fifth rollers 330a to 330e may guide a movement of the glass. In some embodiments, the glass may be transferred sequentially by the first to third rollers 330a to 330c, and then the glass may be transferred by the fourth roller 330d or the fifth roller 330e, and wound by the glass winder 310 into the glass roll R.

In detail, the first roller 330a may guide the glass to the second roller 330b. The second roller 330b may guide the glass from the first roller 330a to the third roller 330c. The third roller 330c may guide the glass from the second roller 330b to the fourth roller 330d or the fifth roller 330e. The fourth roller 330d may guide the glass from the third roller 330c to the glass winder 310. The fifth roller 330e may guide the glass from the third roller 330c to the glass winder 310.

In some embodiments, the first roller 330a may include a load cell roller configured to detect tension of glass. In some embodiments, the second roller 330b may include a dancer roller configured to control the tension of glass. The third to fifth rollers 330c to 330e may include idle rollers.

In some embodiments, the glass winder 310 may be configured to switch between a clockwise mode in which the glass is wound clockwise with the interleaf and a counterclockwise mode in which the glass is wound counterclockwise with the interleaf. When the glass winder 310 is operated in the clockwise mode, the fifth roller 330e may be used for transferring the glass, whereas the fourth roller 330d may not be used therefor. In other words, when the glass winder 310 is operated in the clockwise mode, the fifth roller 330e may contact the glass and the fourth roller 330d may not contact the glass. In contrast, when the glass winder 310 is operated in the counterclockwise mode, the fourth roller 330d may be used for transferring the glass and the fifth roller 330e may not be used therefor. In other words, when the glass winder 310 is operated in the counterclockwise mode, the fourth roller 330d may contact the glass and the fifth roller 330e may not contact the glass.

In some embodiments, the fifth roller 330e may be arranged under the fourth roller 330d. In other words, the fifth roller 330e may be arranged between the fourth roller 330d and the floor FL. In other words, the fourth roller 330d may be spaced apart from the fifth roller 330e in a vertical direction (Z direction).

In some embodiments, the glass winding system 300 may further include a first diameter sensor 315 and a first sensor moving unit 317 adjacent to the glass winder 310. The first diameter sensor 315 may be configured to measure the diameter of the glass roll R. The first sensor moving unit 317 may enable the first diameter sensor 315 to move in a direction parallel to a rotation axis of the glass roll R, in other words, in an X direction. The first sensor moving unit 317 may facilitate measuring the diameter of the glass roll R having various widths with the first diameter sensor 315.

In some embodiments, the glass winding system 300 may control the tension of glass according to the diameter of the glass roll R. For example, the glass winding system 300 may control a force applied to the second roller 330b according to the diameter of the glass roll R. In another example, the glass winding system 300 may control a rotation speed of the glass winder 310 according to the diameter of the glass roll R.

In some embodiments, the glass winding system 300 may further include a second diameter sensor 325 and a second sensor moving unit 327 adjacent to the interleaf unwinder 320. The second diameter sensor 325 may be configured to measure the diameter of the interleaf roll IL. The second sensor moving unit 327 may move the second diameter sensor 325 in a direction parallel to the rotation axis of the interleaf roll IL, that is, the X direction. The second sensor moving unit 327 may facilitate measuring the diameter of the interleaf roll IL having various widths with the second diameter sensor 325.

In some embodiments, the glass winding system 300 may include a position sensor 340 and a moving device 360. The position sensor 340 may be configured to detect a position of glass in a direction parallel to the rotation axis of the glass roll R, that is, the X direction. The position sensor 340 may include, for example, an edge position control (EPC) sensor configured to detect a position of an edge of glass or a center position control (CPC) sensor configured to detect a position of a center of glass. The moving device 360 may move the glass winder 310 according to the position of glass. Accordingly, the moving device 360 may align the glass roll R in the X direction. The moving device 360 may include, for example, an actuator.

The glass winding system 300 may switch between a breaking mode in which glass is broken and a winding mode in which the glass roll R is formed by winding the glass and the interleaf together. To switch between the winding mode and the breaking mode, the breaking unit 350 may be configured to rotate with respect to a rotation axis 350X.

To switch from the winding mode to the breaking mode, first, a space in which the breaking unit 350 rotates may be provided. The first roller 330a at a first position P1 in the winding mode may be removed from the first position P1 in the breaking mode. Also, the second roller 330b at a second position P2 in the winding mode may be removed from the second position P2 in the breaking mode. In some embodiments, the glass winding system 300 may further include a roller holder 370 configured to hold the second roller 330b in the breaking mode. In other words, in the breaking mode, the second roller 330b may be held by the roller holder 370. Next, the breaking unit 350 may be rotated clockwise by about 30° to about 60°.

In contrast, to switch from the breaking mode to the winding mode, the breaking unit 350 may be rotated counterclockwise by about 30° to about 60°. Furthermore, the first roller 330a may be inserted at the first position P1 of the glass winding system and the second roller 330b may be inserted at the second position P2 of the glass winding system 300.

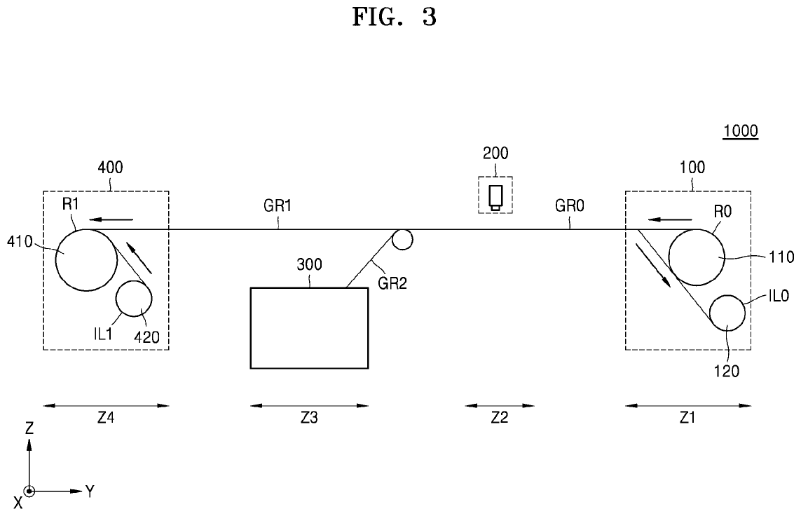

FIG. 3 is a schematic view of a system 1000 for forming glass rolls according to an embodiment of the disclosure.

Referring to FIG. 3, the system 1000 for forming glass rolls may include a glass ribbon supply system 100 in a supply zone Z1, a cutting system 200 in a cutting zone Z2, a first glass winding system 400 in a first winding zone Z4, and a second glass winding system 300 in a second winding zone Z3.

The glass ribbon supply system 100 may provide an initial glass ribbon GR0 from the supply zone Z1 to the cutting zone Z2. In some embodiments, the glass ribbon supply system 100 may include a glass unwinder 110 that provides the initial glass ribbon GR0 by unwinding an initial glass roll R0. In some embodiments, when the initial glass roll R0 includes the interleaf, the glass ribbon supply system 100 may further include an interleaf winder 120 for forming an interleaf roll IL0 by winding the interleaf.

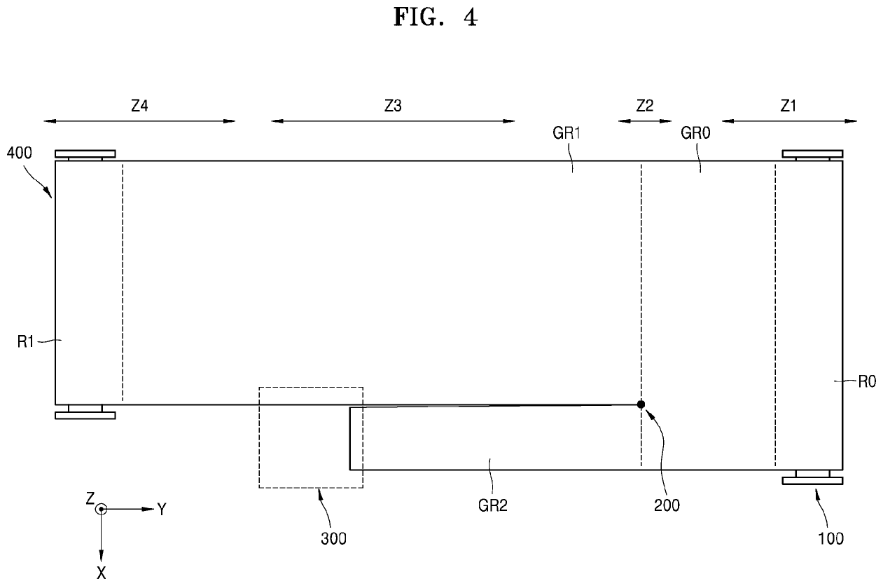

The cutting system 200 may cut, in the cutting zone Z2, the initial glass ribbon GR0 into a first glass ribbon GR1 having a first width and a second glass ribbon GR2 having a second width (see FIG. 4). The cutting system 200 may include, for example, a laser capable of cutting glass.

The first glass winding system 400 may be configured to wind the first glass ribbon GR1 to form a first glass roll R1 in the first winding zone Z4. In some embodiments, the first glass winding system 400 may include a first glass winder 410 configured to wind the first glass ribbon GR1 to form the first glass roll R1 In some embodiments, the first glass winding system 400 may include a first interleaf unwinder 420 that provides the interleaf to the first glass winder 410 by unwinding an interleaf roll IL1.

The second glass winding system 300 may be configured to switch between the breaking mode in which the second glass ribbon GR2 are broken in the second winding zone Z3 and the winding mode in which the second glass ribbon GR2 is wound to form a second glass roll R2. The second glass winding system 300 may be the same as the glass winding system 300 that is described with reference to FIGS. 1 and 2.

The second glass winding system 300 may be arranged between the cutting system 200 and the first glass winding system 400. For example, the first glass winding system 400, the second glass winding system 300, the cutting system 200, and the glass ribbon supply system 100 may be sequentially arranged in a Y direction. As the second glass winding system 300 is arranged between the cutting system 200 and the first glass winding system 400, the second glass winding system 300 does not increase the total length of the system 1000 for forming glass rolls. Accordingly, an increase in difficulty in controlling glass due to an increase in the length of the system 1000 may be prevented.

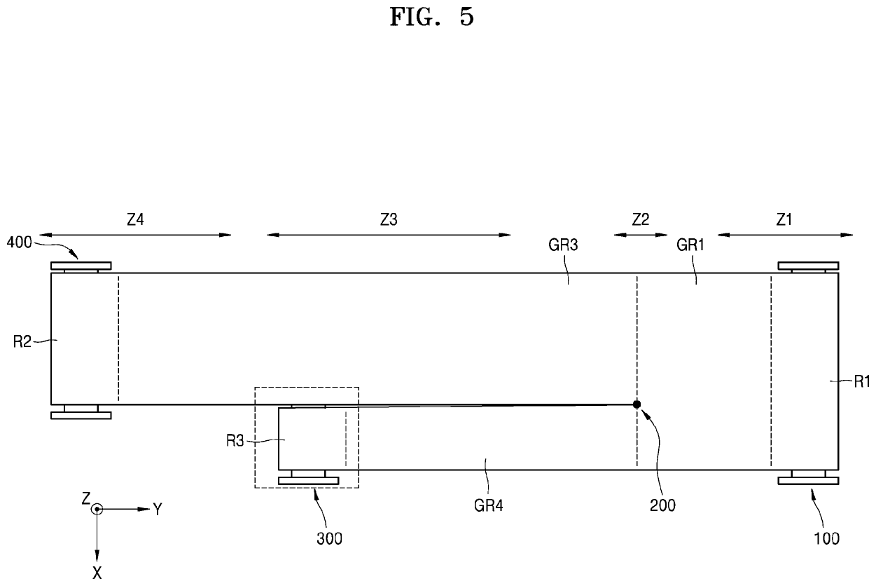

FIGS. 4 and 5 are plan views of a method of forming glass rolls according to an embodiment of the disclosure.

Referring to FIG. 4, the glass ribbon supply system 100 may provide the initial glass ribbon GR0 from the supply zone Z1 to the cutting zone Z2. The thickness of the initial glass ribbon GR0, that is, a thickness in a Z direction may be about 0.05 mm to about 0.5 mm. When the thickness of the initial glass ribbon GR0 is less than about 0.05 mm, the initial glass ribbon GR0 may be too thin and light to handle. In contrast, when the thickness of the initial glass ribbon GR0 is greater than about 0.5 mm, the initial glass ribbon GR0 is less flexible so that the first glass roll R1 may be difficult to form.

The initial glass ribbon GR0 may include for example, silicate glass, borosilicate glass, aluminosilicate glass, boro-aluminosilicate glass, or a combination thereof, each of which may include or may not include an alkali element(s). The initial glass ribbon GR0 may include, for example, Willow® glass, which is obtainable from Corning Incorporated.

In some embodiments, the initial glass ribbon GR0 may be provided by unwinding the initial glass roll R0. When the initial glass ribbon GR0 is provided by unwinding the initial glass roll R0, the method of forming a glass roll according to the present disclosure may be a sort of a roll-to-roll process of forming the first glass roll R1 from the initial glass roll R0.

The cutting system 200 may cut, in the cutting zone Z2, the initial glass ribbon GR0 into the first glass ribbon GR1 and the second glass ribbon GR2. The first glass ribbon GR1 may be transferred from the cutting zone Z2 to the first winding zone Z4, and the second glass ribbon GR2 may be transferred from the cutting zone Z2 to the second winding zone Z3.

The first glass winding system 400 may wind, in the first winding zone Z4, the first glass ribbon GR1 to form the first glass roll R1. Furthermore, the second glass winding system 300 may break the second glass ribbon GR2 in the second winding zone Z3. In other words, the second glass winding system 300 may be operated in the breaking mode. Accordingly, the second glass ribbon GR2 having relatively low edge quality may be separated from the initial glass ribbon GR0 to be disposed of.

Next, referring to FIG. 5, the first glass roll R1 may be transferred from the first winding zone Z4 to the supply zone Z1. Furthermore, the second glass winding system 300 may be switched from the breaking mode to the winding mode. For example, as described with reference to FIG. 2, the breaking unit 350 may be rotated, and then the first roller 330a may be inserted at the first position P1 of the second glass winding system 300, and the second roller 330b may be inserted at the second position P2 of the second glass winding system 300.

Next, the glass ribbon supply system 100 may provide the first glass ribbon GR1 from the supply zone Z1 to the cutting zone Z2, by unwinding the first glass ribbon GR1 from the first glass roll R1. The method of forming a glass roll according to the present disclosure may be a sort of a roll-to-roll process of forming the second glass roll R2 and a third glass roll R3 from the first glass roll R1.

The cutting system 200 may cut, in the cutting zone Z2, the first glass ribbon GR1 into a third glass ribbon GR3 and a fourth glass ribbon GR4. The third glass ribbon GR3 may be transferred from the cutting zone Z2 to the first winding zone Z4, and the fourth glass ribbon GR4 may be transferred from the cutting zone Z2 to the second winding zone Z3.

In the first winding zone Z4, the first glass winding system 400 may wind the third glass ribbon GR3 to form the second glass roll R2. Furthermore, in the second winding zone Z3, the second glass winding system 300 may wind the fourth glass ribbon GR4 to form the third glass roll R3. In other words, the second glass winding system 300 may be operated in the winding mode. As the fourth glass ribbon GR4 is not disposed of, manufacturing costs may be reduced. Furthermore, as the second glass roll R2 and the third glass roll R3 may be simultaneously formed, a production time may be reduced.

In some embodiments, as described with reference to FIGS. 1 and 2, during the winding of the fourth glass ribbon GR4, the position sensor 340 (see FIGS. 1 and 2) may detect the position of the fourth glass ribbon GR4 in a direction parallel to a rotation axis of the third glass roll R3, that is, the X direction. Furthermore, during the winding of the fourth glass ribbon GR4, the moving device 360 (see FIGS. 1 and 2) may move the third glass roll R3 in the X direction according to the position of the fourth glass ribbon GR4. Accordingly, the third glass roll R3 may be aligned in the X direction.

In some embodiments, as described with reference to FIGS. 1 and 2, during the winding of the fourth glass ribbon GR4, the first diameter sensor 315 (see FIGS. 1 and 2) may detect the diameter of the third glass roll R3. Furthermore, the second glass winding system 300 may control the tension of the fourth glass ribbon GR4 according to the diameter of the third glass roll R3.

In FIGS. 4 and 5, a method of forming glass rolls including onebreaking mode step and one winding mode step is described as an example. However, the number and order of the breaking mode steps and the winding mode steps are not limited thereto.

In another embodiment, in a first breaking mode step, a glass roll having a width of about 1150 m may be formed from an initial glass roll having a width of about 1300 m. Glass having a width of about 150 m may be broken. Next, in a second breaking mode step, a glass roll having a width of about 960 m may be formed from a glass roll having a width of about 1150 m. Glass having a width of about 190 m may be broken. Next, in a first winding mode step, a glass roll having a width of about 320 m and a glass roll having a width of about 640 m may be obtained from a glass roll having a width of about 960 m. Next, in a second winding mode step, tow glass rolls, each having a width of about 320 m, may be obtained from a glass roll having a width of about 640 m. Consequently, a total of three glass rolls having a width of about 320 m may be obtained from an initial glass roll having a width of about 1300 m. The above processes may be summarized in Table 1 below.

TABLE 1
Order to form glass rolls

| | | | Width of | Width of |
|---|---|---|---|---|
| | | Width of | glass ribbon | glass ribbon |
| | | glass roll | transferred | transferred |
| | | before | to first | to second |
| Step | Mode | cutting | winding zone | winding zone |
| 1 | Breaking | 1300 | 1150 | 150 |
| 2 | Breaking | 1150 | 960 | 190 |
| 3 | Winding | 960 | 640 | 320 |
| 4 | Winding | 640 | 320 | 320 |

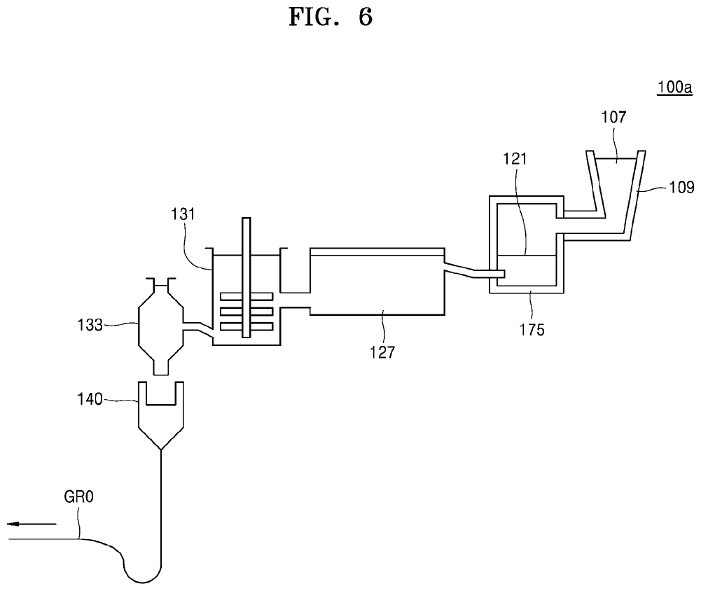

FIG. 6 is a schematic view of a glass ribbon supply system 100a included in a system for forming glass rolls according to an embodiment of the disclosure and used for a method of forming glass rolls according to an embodiment of the disclosure.

Referring to FIG. 6, the glass ribbon supply system 100a may include a glass ribbon manufacturing system configured to manufacture the initial glass ribbon GR0 from a glass material 107. In other words, manufacturing of the initial glass ribbon GR0, cutting thereof, and winding of the cut glass ribbons GR1 and GR2 (see FIG. 3) may be performed continuously and sequentially in the system 1000 for forming glass rolls (see FIG. 3).

The glass ribbon supply system 100a may include a melting vessel 175 for forming molten glass 121 by melting the glass material 107 and a forming vessel 140 for forming the initial glass ribbon GR0 from the molten glass 121. Although FIG. 6 illustrates that the forming vessel 140 is of a down draw type, any type of a forming vessel, for example, a slot draw type forming vessel, a float bath type forming vessel, or an up draw type forming vessel, may be used.

In some embodiments, the glass ribbon supply system 100a may further include a storing and delivery vessel 109 for storing the glass material 107 and delivering the stored glass material 107 to the melting vessel 175.

In some embodiments, the glass ribbon supply system 100a may further include a fining vessel 127 located at the downstream of the melting vessel 175. Air bubbles may be removed from the molten glass 121 in the fining vessel 127.

In some embodiments, the glass ribbon supply system 100a may further include a mixing vessel 131 located at the downstream of the fining vessel 127. The mixing vessel 131 may reduce irregularity in the molten glass 121 by mixing the molten glass 121.

In some embodiments, the glass ribbon supply system 100a may further include a delivery vessel 133 located at the downstream of the mixing vessel 131 and configured to delivery the molten glass 121 to the forming vessel 140. The delivery vessel 133 may function as an accumulator and/or a flow controller to provide the molten glass 121 to the forming vessel 140 in a constant flow.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A glass winding system comprising:
a glass winder configured to wind glass with an interleaf to form a glass roll;
an interleaf unwinder configured to unwind the interleaf from an interleaf roll; and
a breaking unit configured to break the glass,
wherein the glass winding system is configured to switch between a breaking mode in which the glass is broken and a winding mode in which the glass is wound with the interleaf to form the glass roll.

2. The glass winding system of claim 1, wherein the breaking unit is further configured to rotate with respect to a rotation axis to allow the glass winding system to switch between the breaking mode and the winding mode.

3. The glass winding system of claim 1, further comprising a first roller used at a first position in the winding mode,
wherein the first roller is removed from the first position in the breaking mode.

4. The glass winding system of claim 1, further comprising:
a second roller used at a second position in the winding mode, wherein the second roller is removed from the second position in the breaking mode; and
a roller holder configured to hold the second roller in the breaking mode.

5. The glass winding system of claim 1, being arranged on a floor, wherein the glass winder is arranged between the floor and the interleaf unwinder.

6. The glass winding system of claim 1, wherein the glass winder is configured to switch between a clockwise mode in which the glass is wound clockwise with the interleaf and a counterclockwise mode in which the glass is wound counterclockwise with the interleaf.

7. The glass winding system of claim 6, further comprising:
a third roller used in the clockwise mode and not used in the counterclockwise mode; and
a fourth roller used in the counterclockwise mode and not used in the clockwise mode.

8. The glass winding system of claim 1, further comprising:
a first diameter sensor configured to measure a diameter of the glass roll; and
a first sensor moving unit configured to move the first diameter sensor in a direction parallel to a rotation axis of the glass roll.

9. The glass winding system of claim 8, being configured to control a tension of the glass according to the diameter of the glass roll.

10. The glass winding system of claim 1, further comprising a load cell roller configured to sense a tension of the glass.

11. The glass winding system of claim 1, further comprising a dancer roller configured to control a tension of the glass.

12. The glass winding system of claim 1, further comprising:
a second diameter sensor configured to measure a diameter of the interleaf roll; and
a second sensor moving unit configured to move the second diameter sensor in a direction parallel to a rotation axis of the interleaf roll.

13. The glass winding system of claim 1, further comprising:
a position sensor configured to sense a position of the glass in a direction parallel to a rotation axis of the glass roll; and
a moving device configured to move the glass winder according to a position of the glass.

14. A system for forming glass rolls, the system comprising:
a glass ribbon supply system configured to supply an initial glass ribbon;
a cutting system configured to cut the initial glass ribbon into a first glass ribbon and a second glass ribbon;
a first glass winding system configured to wind the first glass ribbon to form a first glass roll; and
a second glass winding system configured to switch between a breaking mode in which the second glass ribbon is broken and a winding mode in which the second glass ribbon is wound to form a second glass roll.

15. The system of claim 14, wherein the glass ribbon supply system comprises a glass unwinder configured to unwind the initial glass ribbon from an initial glass roll.

16. The system of claim 14, wherein the second glass winding system comprises:
a glass winder configured to wind the second glass ribbon to form the second glass roll; and
a breaking unit configured to break the second glass ribbon,
wherein the breaking unit is rotatable with respect to a rotation axis to allow the second glass winding system to switch between the breaking mode and the winding mode.

17. The system of claim 16, wherein the second glass winding system further comprises a first roller used at a first position in the winding mode, and
the first roller is removed from the first position in the breaking mode.

18. The system of claim 16, wherein the second glass winding system further comprises:
a second roller used at a second position in the winding mode, the second roller is removed from the second position in the breaking mode; and
a roller holder configured to hold the second roller in the breaking mode.

19. The system of claim 16, wherein the second glass winding system further comprises an interleaf unwinder configured to unwind an interleaf from an interleaf roll,
the second glass winding system is arranged on a floor, and
the glass winder is arranged between the floor and the interleaf unwinder.

20. The system of claim 16, wherein the glass winder is configured to switch between a clockwise mode in which the second glass ribbon is wound clockwise and a counterclockwise mode in which the second glass ribbon is wound counterclockwise.

21.-35. (canceled)
